(19) United States
(12) Patent Application Publication
(10) Pub. No.: US 2003/0198295 A1
(43) Pub. Date: Oct. 23, 2003

(54) Global elimination algorithm for motion estimation and the hardware architecture thereof

(76) Inventors: Liang-Gee Chen, Shindian (TW); Yu-Wen Huang, Taipei (JP); Shao-Yi Chien, Taipei (TW)

Correspondence Address: KAO H. LU, 686 LAWSON AVE, HAVERTOWN, PA, 19083, US

(21) Appl. No.: 10/183,844

(22) Filed: Jun. 27, 2002

(30) Foreign Application Priority Data
Apr. 12, 2002 (TW) 091107124

(51) Int. Cl. H04N 7/12

(52) U.S. Cl. 375/240.16; 375/240.12; 375/240.24

(57) ABSTRACT

A global elimination algorithm for motion estimation and the hardware architecture thereof that can efficiently remove the braches in the data flow, so that the data flow is smoothened and is more adapted for hardware implementation. Because the processing time for each motion vector is fixed, preliminary prediction can be eliminated. The elimination ratio of the search locations will not be varied with time change and thus can be increased. The global elimination algorithm can produce a search result of high accuracy that is identical to that of a full-search block matching algorithm. The peak signal-to-noise ratio of global elimination algorithm is at times better than that of full-search block matching algorithm. Compared with other architectures based on the full-search block matching algorithm, the hardware architecture of the present invention can provide a best computational capability for each logic gate, while the power consumption of logic gates is minimum under the same throughput of motion vector.

### FIELD OF THE INVENTION

The present invention is related to a block matching motion estimation algorithm for use in a multimedia video compression system, and more particularly, the present invention is related to a high-efficiency global elimination algorithm for motion estimation and the hardware architecture thereof that can reduce the inherent temporal redundancy within a video sequence to achieve the object of video compression.

### BACKGROUND OF THE INVENTION

With the rapid advancement in the video compression technique developed by high-technology industry, the amount of data flow and transmission quality in a video sequence transmission are becoming more and more important. As far as the video sequence is concerned, because the required storage space is quite huge, it is highly desirable to reduce the storage space that is occupied by the video sequence. As a result, the video sequence has to be compressed, and thus video compression technique is necessary to be used as a basic element in an image processing system. The video compression technique generally involves the reduction of the inherent redundancy within a video sequence to achieve the object of video compression. It is known that motion estimation algorithm is a video compression technique based on the requirement to reduce the inherent redundancy within a video sequence.

The motion estimation algorithm generally describes the way of how to find the best-matched candidate block within the reference frame with the current block within the current frame. Among numerous motion estimation algorithms, the most widely used one is referred to as full-search block matching algorithm. The full-search block matching algorithm has a great amount of computation that cannot be handled by current general-purpose microprocessors for real-time applications. Due to the regular data flow in the full-search block matching algorithm, a variety of parallel or pipelined hardware architectures have been addressed. Unfortunately, among these architectures, the computational speed of 1-D array architecture in terms of required clock cycles is too slow. Thus, for large-frame and wide-range search application, the operating frequency of 1-D array architecture must be greatly increased. Though the computational speed of 2-D array architecture in terms of required clock cycles is faster than that of 1-D array architecture, the amount of logic gates is too large and thus its cost is excessive. The tree architecture though conducts a good performance on computational speed and area; however, it requires a larger memory bit-width, which results in a reduced feasibility.

In order to reduce the large computation of the full-search block matching algorithm, successive elimination algorithm (sea) is proposed that can produce identical result with the full-search block matching algorithm. The successive elimination algorithm is provided with a better computational effort than other rapid search algorithms that carry out block search at the cost of peak signal-to-noise ratio (PSNR), for example, three-step search, diamond search or 2-D log search. The computational flow of the successive elimination algorithm is illustrated in FIG. 1. First, the successive elimination algorithm value sea(m,n) of each search location is computed at step S10. Next at step S12, the successive elimination algorithm value sea(m,n) is compared to determine whether it is larger than a minimum of sum of absolute difference SADₘᵢₙ. If sea(m,n)>SADₘᵢₙ, the algorithm continues with step S14 in which the search location (m,n) is skipped and directly continues with step S22. If sea(m,n)<SADₘᵢₙ, the algorithm continues with step S16 to continuously compute the sum of absolute difference SAD(m,n) of each search location. After the sum of absolute difference SAD (m,n) is generated, the algorithm continues with step S18 to compare SAD(m,n) with SADₘᵢₙ. If SAD(m,n)>SADₘᵢₙ, the algorithm continues with step S22, otherwise, if SAD(m,n)<SADₘᵢₙ, the algorithm continues with step S20 to update the minimum of sum of absolute difference SADₘᵢₙ and continues with step S22. Step S22 is a decision that determines whether the current search location (m,n) is the last search location. If yes, it indicates that the location where the minimum SAD value is existed is found, and the algorithm continues with step S26 to produce the estimated motion vector MV and the whole process is complete. If no, it indicates that other locations have not been searched, and the algorithm continues with step S24 to update the next search location (m,n) and continues with step S10 to repeat the above steps.

After the sea value corresponding to each search location has been computed, branches might occur to the computational flow which may cause the data flow to be quite irregular and can not be predicted in advance. Therefore it is not possible to use systolic array architecture to design the hardware architecture. Even the multi-level successive elimination algorithm is developed afterwards; the same problems still cannot be obviated.

Furthermore, the successive elimination algorithm has to make a preliminary prediction on the motion vector (MV) so as to effectively reduce the computational amount. Nevertheless, it is pretty difficult to make a preliminary prediction on the motion vector within an area that is in irregular motion. In addition, if the real motion vector is beyond the search range, the elimination ratio of the search locations for successive elimination algorithm will be even as low as to cause its computational time to be longer than that of full-search block matching algorithm. Further, in order to increase the number of times of eliminating the computation of sum of absolute difference, the successive elimination algorithm typically uses spiral scan technique to determine the priority of search locations. Under this condition, hardware circuitry normally has to pay a higher cost than using conventional raster scan technique.

It would be desirable to address a global elimination algorithm and a hardware architecture thereof that can efficiently remove the drawbacks arising from the prior successive elimination algorithm.

### SUMMARY OF THE INVENTION

It is an object of the present invention is to provide a global elimination algorithm for motion estimation and a hardware architecture thereof that removes the branches of the data flow appropriately to allow the data flow to be more regular, smoother, more adapted for hardware implementation.

Another object of the present invention is to provide a global elimination algorithm, wherein there is a high similarity between its search result and the search result of full-search block matching algorithm, with a better peak signal-to-noise ratio (PSNR) at times and a higher reliability.

Another further object of the present invention is to provide a hardware architecture of a global elimination algorithm for motion estimation, wherein the computational capability with respect to each logic gate is the best compared with other architectures based on the full-search block matching algorithm, while the power consumption of the logic gates under the same throughput of motion vector is the lowest.

Another yet object of the present invention is to provide a global elimination algorithm for motion estimation and a hardware architecture thereof that is subjected to support advance prediction mode.

To theses ends, the present invention suggests a global elimination algorithm for motion estimation, including steps of: representing current blocks within current frame in candidate blocks within reference frame on each search location in terms of coarse patterns, comparing the coarse patterns in the reference block and the candidate blocks, searching M candidate blocks that hold a coarse pattern similar to the current block, and comparing fine patterns of the M candidate blocks with those of the current blocks, and selecting candidate blocks that holds a minimum of difference of the fine patterns of the M candidate blocks.

Another aspect of the present invention is associated with a hardware architecture of performing global elimination algorithm for motion estimation, including: a systolic module for computing coarse patterns of each sub-blocks in parallel, an adder tree for comparing each coarse pattern of reference blocks with each coarse pattern of candidate blocks, wherein the adder tree is reusable to comparing each fine pattern of the current blocks with each fine pattern of the candidate blocks, at least one comparator tree for searching for M candidate blocks that has a coarse pattern similar to the current block, a control device for controlling operations of the systolic module, the adder tree and the comparator tree, and at least one memory for storing data of the current block and the candidate blocks.

The present invention will become more apparent through the following descriptions with reference to the accompanying drawings, wherein:

### BRIEF DESCRIPTION OF THE DRAWINGS

FIG. 1 illustrates a computational flow of the prior successive elimination algorithm;

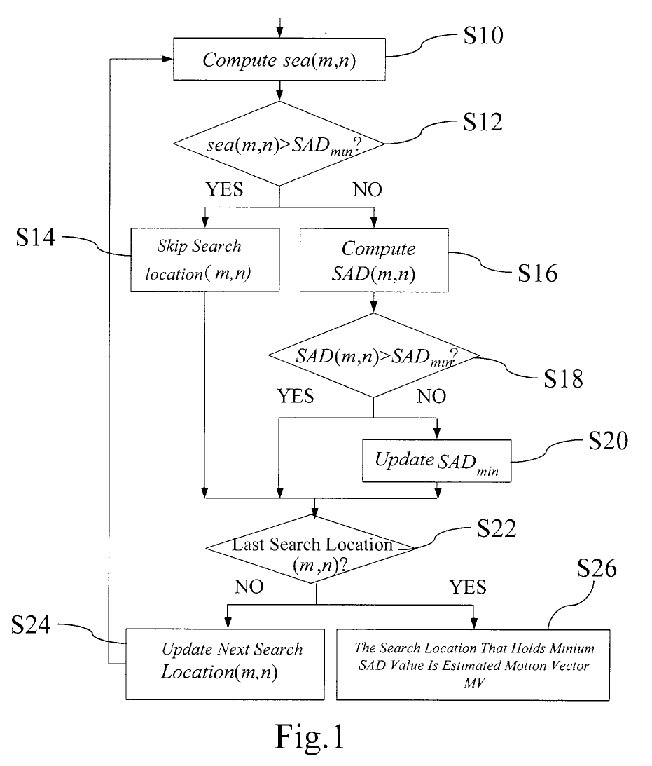

FIG. 2 is a flowchart illustrating the global elimination algorithm according to the present invention;

FIG. 3 shows the percentage of the identical motion vector of the global elimination algorithm and the full-search block matching algorithm in mobile calendar CIF video sequence;

FIG. 4 shows the peak signal-to-noise ratio pattern curves of the global elimination algorithm and the full-search block matching algorithm in mobile calendar CIF video sequence;

FIG. 5 shows the hardware architecture of the present invention;

FIG. 6 shows the architecture of the systolic module according to the present invention;

FIG. 7 shows the architecture of the parallel adder tree according to the present invention;

FIG. 8 shows the architecture of the parallel comparator tree according to the present invention; and

FIG. 9 shows that the way of allowing the hardware architecture according to the present invention to support the advanced prediction mode.

### DETAILED DESCRIPTION OF THE PREFERRED EMBODIMENT

It has been already known by anyone skilled in the art that motion estimation is a key component in video compression technique field, and is applicable to multimedia electronic products, such as digital camcorders. The present invention presents a novel global elimination algorithm for motion estimation and a hardware architecture thereof that can appropriately reduce the branches within a computational data flow, such that the data flow is more regular, more adapted for hardware implementation and has the features of high reliability, fast computational speed and high efficiency, while the drawbacks generated by prior (multi-level) successive elimination algorithm are obviated.

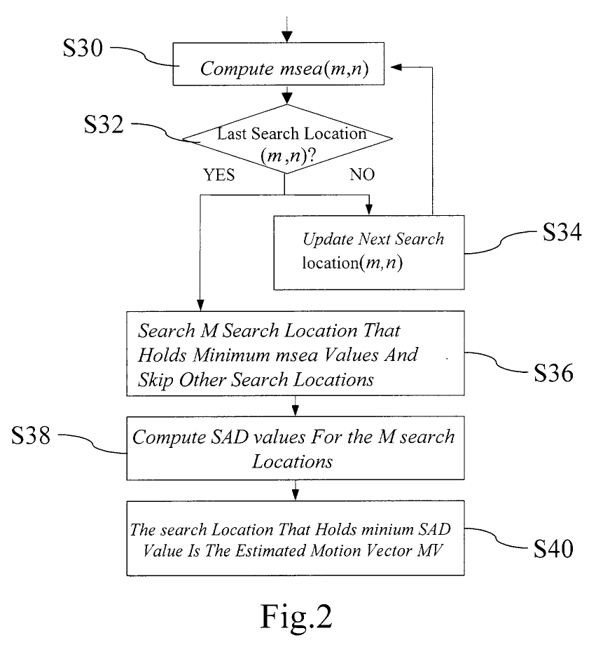

FIG. 2 is a flowchart illustrating the global elimination algorithm according to the present invention. As can be seen, the global elimination algorithm according to the present invention comprises the following steps of: First, computing the multi-level successive elimination algorithm msea (m,n) value for each search location at step S30. At step S32 it is determined that the search location (m,n) is the last one. If the search location (m,n) is not the last one, the algorithm continues with step S34 to update next search location (m,n) and back to step S30 to repeat the above steps. At step S34, the priority of update to the search location can be set at random, and will not affect the final search result. Therefore the conventional raster scan technique may be used. If the search location (m,n) is the last one, the algorithm directly continues with step S36 to set the search range as between −p and p−1. At step 36, M search locations that holds the minimum msea value among all the (2p)² search locations will be found out, while other [(2p)²−M] search locations are eliminated. After step S36 is complete, the algorithm continues with step S38 to compute the sum of absolute difference SAD(m,n) for each search location. Finally the algorithm continues with step S40 to select a minimum of the sum of absolute difference among the SAD values of the M search locations. The search location that holds a minimum SAD value is exactly the motion vector estimated by the global elimination algorithm.

The reason of why this algorithm is termed global elimination can be understood by virtue of step S32 of FIG. 2. Unlike the (multi-level) successive elimination algorithm that checks the search locations one by one to determine which search location can be eliminated, the global elimination algorithm will determine which search location can be eliminated after the msea value (multi-level successive elimination algorithm value) corresponding to all the search locations have been computed. During the computation process for the msea value corresponding to each search locations, the computation will run along with the right-hand side braches, and the data flow becomes continuous and regular. Therefore, the systolic array architecture may be used to implement the hardware architecture design.

The selection of the value of M is a trade-off between computational speed and encoding efficiency. Preferably the value of M is interposed between multi-level successive elimination algorithm values, for example, between 1 and 63. In general, the larger the value of M is, the slower the computation speed will be, however, the encoding efficiency is higher. On the contrary, the smaller the value of M is, the faster the computation speed will be, however, the encoding efficiency is lower. No matter what the value of M is, the processing time required by each motion vector is fixed and predictable. This is more helpful to the work scheduling of hardware-implemented encoding system.

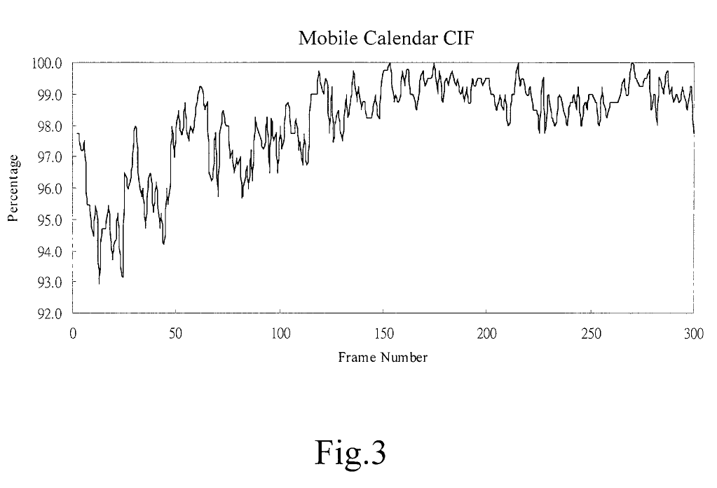

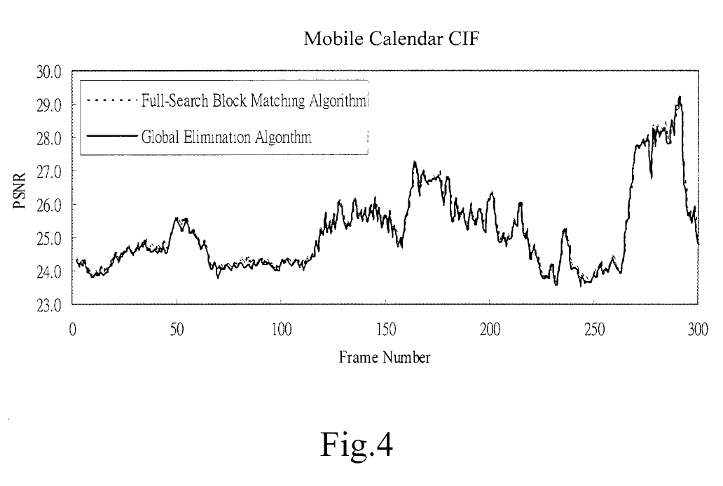

Though global elimination algorithm can not guarantee the search result is 100% identical to that of the full-search block matching algorithm as (multi-level) successive elimination algorithm, the global elimination algorithm is still quite reliable. The present invention gives a large number of tests for two common conditions. The first condition is a QCIF (176×144) frame, with 16×16 blocks, a search range of −16-+15, msea value of the third-level and M=7, as well as the ratio of search location where the computation of SAD is skipped is 99.31%. The second condition is a CIF (352×288) frame, with 16×16 blocks, a search range of −32-+31, msea value of the third-level and M=7, as well as the ratio of search location where the computation of SAD is skipped is 99.83%. The rest result is shown in Table.1. The verification process of the test experiments with a large number of standard test video sequences, and it is found that the average PNSR of the frames that are compensated by using global elimination algorithm is very close to the result of full-search block matching algorithm. The largest but still insignificant difference is that the Hall Monitor item of the CIF frame compensated by using global elimination algorithm is lower than that of the CIF frame compensated by using full-search block matching algorithm by 0.08 dB. In addition, the average PNSR of the frames that are compensated by using global elimination algorithm is at times higher than that compensated by using full-search block matching algorithm, such as Foreman QCIF, Silent QCIF and Table Tennis QCIF. It is wrong to consider that the PNSR of full-search block matching algorithm is maximum. This is because the minimum SAD value can not guarantee the minimum mean square error, for example, 1+9<5+6, while 1²+9²>5²+6². In most of time, the result of global elimination algorithm is quite close to that of full-search block matching algorithm, which can be best understood from FIGS. 3 and 4. FIG. 3 shows the percentage of the identical motion factor of the global elimination algorithm and the full-search block matching algorithm in Mobile Calendar CIF video sequence. It can be seen from FIG. 3 that 98.1% of motion vectors are averagely identical in 300 frames. FIG. 4 shows the peak signal-to-noise ratio pattern curves of the global elimination algorithm and the full-search block matching algorithm in Mobile Calendar CIF video sequence. Because these two curves are quite close to each other, it is somewhat difficult to differentiate between then. Consequently, it reveals that the global elimination algorithm according to the present invention is of great reliability in according with the statistics listed in the statistic table and chart.

TABLE 1
Unit: dB

| | (a) | | (b) | |
|---|---|---|---|---|
| | Full-Search | | Full-Search | |
| | Block | Global | Block | Global |
| Standard Video | Matching | Elimination | Matching | Elimination |
| Sequence | Algorithm | Algorithm | Algorithm | Algorithm |
| Coastguard | 32.93 | 32.93 | 31.59 | 31.55 |
| Container | 43.11 | 43.11 | 38.53 | 38.53 |
| Foreman | 32.21 | 32.22 | 32.85 | 32.82 |
| Hall Monitor | 32.98 | 32.97 | 34.90 | 34.82 |
| Mobile | 26.15 | 26.15 | 25.20 | 25.16 |
| Calendar | | | | |
| Silent | 35.14 | 35.16 | 36.12 | 36.11 |
| Stefan | 24.71 | 24.67 | 25.73 | 25.71 |
| Table Tennis | 32.10 | 32.11 | 33.03 | 32.96 |
| Weather | 38.42 | 38.42 | 37.45 | 37.45 |

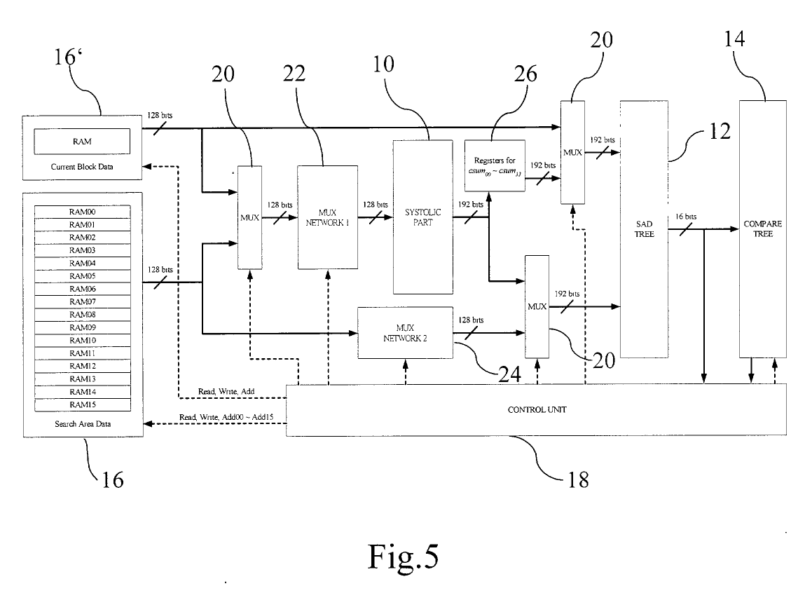

After the global elimination algorithm according to the present invention has been described, the corresponding hardware architecture will be described in more detail in the following. The present invention now will be described by taking a block of the size of 16×16, msea value of the third-level and m=7 as an example, with the aid of FIG. 5 to enable the person skilled in the art to obtain a sufficient understanding to implement the present invention in reference to the embodiment disclosed herein. As shown in FIG. 5, the hardware architecture adapted for motion estimation algorithm includes a systolic module 10, a parallel adder tree 12, a parallel comparator tree 14, control device for controlling the operation of respective element, and memory 16 used to store the candidate blocks within the reference frame and memory 16′ used to store the current block within the current frame. The control device includes a control unit 18 and a control circuit made up of a multiplexer (MUX) 20 and MUX networks 1 (22) and MUX networks 2 (24).

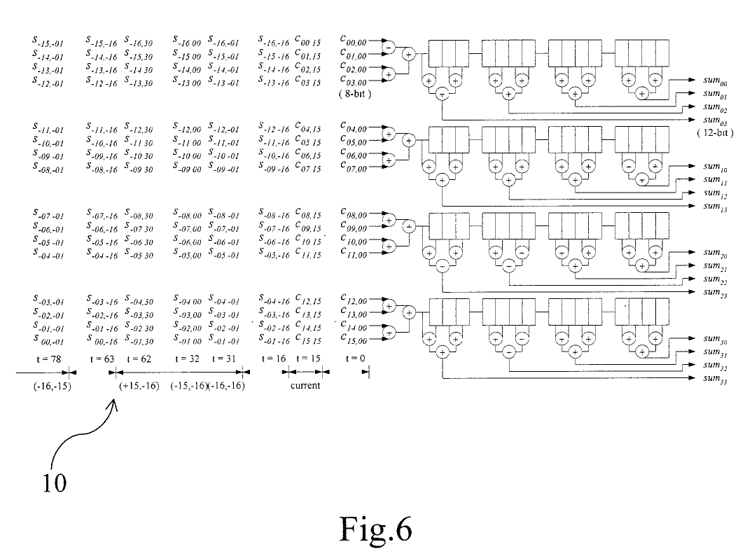

As shown in FIG. 5, the systolic module 10 is used to compute the sum of the pixel intensity within sixteen sub-blocks of a block size of 16×16 in the same cycle, i.e. coarse pattern, and output the computational result in parallel. FIG. 6 shows the data flow within the systolic module 10, in which C_{1, k} and S_{1, k} respectively represent the current block data c(k,1) and search area data s(k,1). The rectangles as indicated in the drawing are representative of shift registers 26, and the search range is set between −16-+15 as an example. The block data is loaded into the systolic module 10 column by column in parallel. When t=0-15, the current block data is loaded into the systolic module 10, and the sum of pixel intensity within individual sixteen 4×4 sub-blocks of the 16×16 current block (which is indicated in FIG. 6 by sum₀₀-sum₃₃, and shown as csum₀₀-csum₃₃) is computed when t=15, and is saved in the sixteen 12-bit registers at the positive edge of the clock when t=16. Next, the search block data is loaded into the systolic module 10. When t=16-62, the candidate blocks within the search locations (−16,−16)-(+15,−16) will be loaded, and the sum of pixel intensity within individual sixteen sub-blocks within the search locations (−16,−16)-(+15,−16) of the candidate block (which is indicated in FIG. 6 by sum₀₀-sum₃₃, and shown as rsum₀₀-rsum₃₃) is computed when t=31-62. The search block data of the next row is computed in the same way. The candidate block data within the search locations (−16,−15)-(+15,−15) is loaded when t=63-109, and the sum of pixel intensity within individual sixteen sub-blocks within the search locations (−16,−16)-(+15,−15) of the candidate block is computed at t=31-62. It can be known through the foregoing discussions that each row of search location needs (2p+N−1) clock cycles to compute the sum of pixel intensity, together with N clock cycles to load the current block data. Therefore the systolic module 10 needs N+2p (2p+N−1) clock cycles to compute the sum of pixel intensity (coarse pattern) within the sub-blocks of all the blocks.

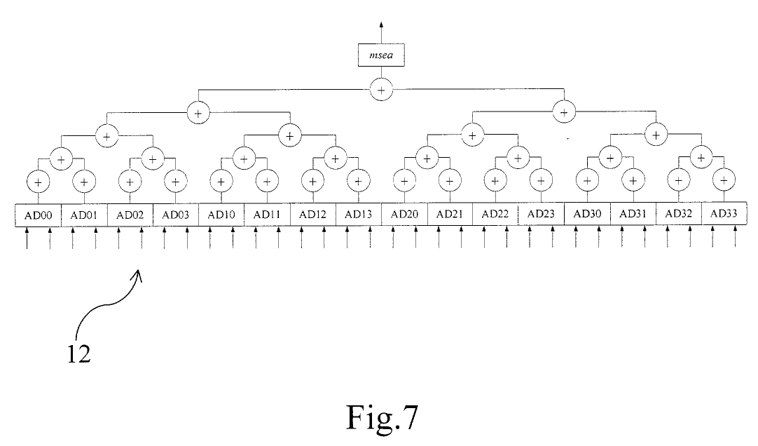

The pixel intensity of the sub-blocks and identical result computed by the systolic module 10 is transferred to the parallel adder tree 12. Please refer to FIGS. 6 and 7, the purpose of the parallel adder tree 12 is to compute the msea value by way of the equations listed below:

$$\begin{matrix}SAD ( m , n ) = {\sum }_{i = 0}^{N - 1} {\sum }_{j = 0}^{N - 1} \vert c ( i , j ) - s ( i + m , j + n ) \vert \\ \geq {\sum }_{q = 0}^{L - 1} \vert {K}_{q} - {SB}_{q} ( m , n ) \vert ≡ msea ( m , n ) \\ \geq \vert {\sum }_{i = 0}^{N - 1} {\sum }_{j = 0}^{N - 1} c ( i , j ) - {\sum }_{i = 0}^{N - 1} {\sum }_{j = 0}^{N - 1} s ( i + m , j + n ) \vert \\ ≡ \vert K - SB ( m , n ) \vert ≡ sea ( m , n )\end{matrix}$$

In above equation, K stands for the sum of pixels within the current block, and SB(m,n) stands for the sum of pixels within the candidate block at search location (m,n). The absolute difference between K and SB is exactly the sea value, which is also called msea value of first order. If a block is divided into L sub-blocks, wherein K_{q} stands for the sum of pixel of the q-th sub-block of the current block and SB_{q}(m,n) stands for the sum of pixel of q-th sub-block of the candidate block at the search location (m,n), the msea value can be obtained by adding up the absolute differences of the total L of K_{q} and SB_{q}. If a block is divided into 4^{Level-1} sub-blocks of identical size, it is sometimes referred to as successive elimination of Level-th level. For example, successive elimination of third level is to divide a block of the size of 16×16 into sixteen 4×4 sub-blocks. The element with the notation of ADXX as indicated in FIG. 7 is used to compute the absolute difference between the sum csumₓₓ of the pixel intensity of the sub-blocks of the current block and the sum rsumₓₓ of the pixel intensity of the sub-blocks of the candidate block. The adder tree 12 is used to add up the result of AD00-AD33 to obtain the msea value.

After the msea value of each block is sequentially obtained, it will be inputted into the parallel comparator tree 14 to find out the M search locations corresponding to the minimum msea value. The parallel comparator tree 14 is used to save the current minimum msea value as well as the corresponding motion vector into registers. If the inputted msea value is smaller than one or more of the M msea values, the maximum msea value will be replaced with the inputted msea value. If more than two of the M msea values are the maximum, only one has to be replaced with the inputted msea value.

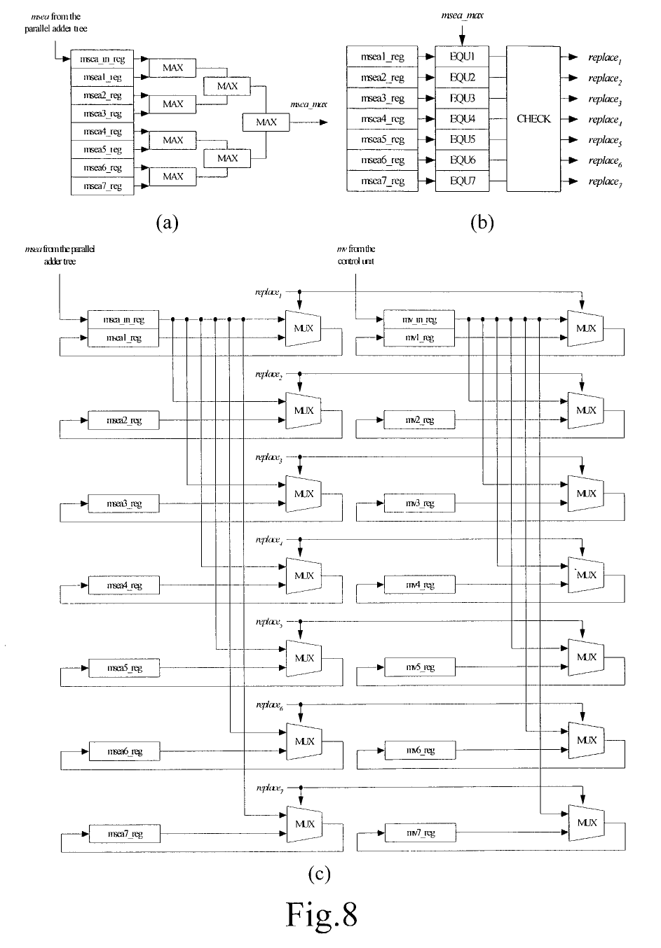

FIG. 8 shows a circuit diagram of the parallel comparator tree according to the present invention, in which the element symbolized by a notation of “_reg” is indicative of a shift register and the element symbolized by a notation of “MAX” is indicative of a comparator. In the diagram (a), part of the circuit has to set the initial value of the register mseal_reg-msea7_reg as 0×FFFF (65535) before the effective msea value from the parallel adder tree 12 enters. This part of circuit will compute the maximum msea_max of the msea_in_reg and mseal_reg-msea7_reg, and the comparator MAX will output a maximum of the two inputs. The circuit as shown in diagram (b) is used to compute the maximum msea_max between the value of register msea_in_reg and the value of register msea_in_reg, and the comparator will output the maximum between the two inputs. The element EQUX is used to compare among registers mseax_reg, x=1-7, and CHECK circuit is used select one among more than two registers mseax_reg while all of them contain the maximum of msea_max. That is to say, while the replace signal replaceₓ is active, it indicates that the register mseax_reg and the register mvx_reg should be replaced with register msea_in_reg and register mv_in_reg respectively, and no more than one replace signal replaceₓ is active. The circuit as shown in diagram (c) is used to take charge of replacement opeation, wherein the element MUX is a multiplxer in the control of replace signal replaceₓ.

In this way, the minimum M msea values and the corresponding motion vectors can be saved in registers at anytime. Until the msea values of all the search locations (candidate blocks) are inputted into the parallel adder tree 14, the register contains M minimum msea values among (2p)² search locations and the corresponding motion vectors. Subsequently, the SAD values at the M search locations will be computed and a minimum will be found out, and the motion vector is outputted to complete the estimation of a motion vector. It should be noted that when the field data at the search locations of each row is inputted into the systolic module 10, the msea value generated by the parallel adder tree 12 during the former (N−1) clock cycles is invalid. Here the msea value to be inputted to the parallel adder tree 12 has to replaced with the value of 0×FFFF (65535) so as to produce correct result.

In order to output the column data of candidate blocks in parallel, the operation of the hardware architecture should act in such a way as follows: The data within the search range totally has (2p+N−1) rows. According to the present invention, the row data are numbered from 0 to (2p+N−2), wherein the row data with a remainder of 0 being generated by diving its number by N is stored in RAM00 of memory 16, while the row data with a remainder of 1 being generated by diving its number by N is stored in RAM01, as shown in FIG. 5. Thus, the column data can be outputted in parallel with the N RAM modules controlled by N proper addresses. As for the current block data, its column data are stored in another 128-bit (assume N=16) memory 16′ in order to be outputted in parallel. While the column data of candidate blocks are outputted, they must pass through the multiplexer network 1 (22) before entering systolic module 10 to allow them to enter correct sub-block. Under the condition of N=16 and Level=3, the multiplexer network 1 (22) comprises sixteen 4-to-1 8-bit multiplexers. On the search locations of different rows, the control signal that is used to control the multiplexer network 1 (22) has to be appropriately adjusted.

Similarly, while computing the SAD values of M search locations, the data of candidate blocks has to pass through the second multiplexer network 24 and then enters the parallel adder tree 12, which is made up of sixteen 16-to-1 8-bit multiplexer. The control signals for controlling the second multiplexer network 24 have to be modulated for the search locations of different rows. Therefore, the present invention requires N+2p(2p+N−1) clock cycles to find out M search locations where a minimum sea value is held. When it is desired to compute the SAD value of these M search locations, the resource of the parallel adder tree 12 can be reused. Each search locations needs N clock cycles to compute its SAD value, and M search locations need (M×N) clock cycles to compute the total SAD values. In conclusion, taking an example of which N=16 and Level=3, the hardware architecture according to the present invention needs N+2p(2p+N−1)+(M×N) clock cycles to compute a motion vector.

Thus, the spirit and principle of the present invention has been described. A specific experimental embodiment will soon be brought up to verify the above-described principle and effect. In order to analyze the performance of the hardware architecture according to the present invention, the hardware architecture of the present invention will be compared with the hardware architecture based on the full-search block matching algorithm, wherein the architectures to be compared are originated from References [1]-[7] listed at the end of specification. The comparison result is shown in Tables 2 and 3, wherein Table 2 demonstrates a comparison between different architectures under the conditions of 16×16 block, −16-+15 search range, Level=3 and M=7, and Table 3 demonstrates a comparison between different architectures under the conditions of 16×16 block, −32-+31 search range, Level=3 and M=7.

The comparison takes place in terms of the processing element array, while the control circuit plays an insignificant part in these architecture and thus is not implemented in the form of hardware. The processing element array is synthesized by SYNOPSYS Design Analyzer with AVANT! 0.35 μm Cell Library, and the Critical Path Constraint is set as 20 ns, i.e. the working frequency of the circuit can reach at least 50 MHz. The architectures shown in Tables 2 and 3 labeled with an asterisk represent that in addition to processing elements, a large number of additional logic circuits that are mostly comprised of shift register are needed to increase the reusability of data. Consequently, the actual gate counts and power consumption of the logic gates of these hardware architectures will be much higher than those of simulation. In Tables. 2 and 3, it is to be noted that the memory, second multiplexer network and control unit are not implemented in the simulation, while other elements have been taken into account in the simulation. In addition, three-stage pipelines are cut out in the simulation.

For the purpose of comparing these hardware architectures fairly, they must be compared based on the same throughput of motion vector (motion vectors/second). Therefore, we define “normalized processing capability per gate (NPCPG)” and “normalized power (NP)” respectively as:

$$\begin{matrix}{NPCPG}_{XXX} = \frac{[ {( Required Freq . for CIF 30 fps )}^{- 1} / ( Gate Count @ 50 MHz ) ] for XXX}{[ {( Required Freq . for CIF 30 fps )}^{- 1} / ( Gate Count @ 50 MHz ) ] for GEA} \\ {NP}_{XXX} = \frac{[ ( Power @ 50 MHz ) \times ( Required Freq . for CIF 30 fps / 50 MHz ) ] for XXX}{[ ( Power @ 50 MHz ) \times ( Required Freq . for CIF 30 fps / 50 MHz ) ] for GEA}\end{matrix}$$

In general, the computational speed of 1-D array architecture in terms of required clock cycles is not fast enough, and its operating frequency must increase for large-frame and wide-range search application. On the other hand, though the computational speed of 2-D array architecture is faster compared with that of 1-D array architecture, the amount of logic gate is large and its cost is excessive. The architecture of reference [6] though is to be a kind of 1-D array architecture; it takes data-interlacing and 2-D data reuse, and thus has the same problems with the 2-D array architecture, i.e. large amount of logic gates. Though the tree architecture conducts a good performance on computational speed and area, the required memory bit width is too large, and thus results in a reduced feasibility. The computational speed of the hardware architecture according to the present invention is substantially somewhat slower than the 2-D array architecture and tree architecture (the computational speed of architecture [3] is slower than the present invention), however, the amount of logic gate according to the present invention is much less than those architectures. Taking a 1-D array architecture into consideration, the computational speed of the 1-D array architecture is much slower than that of the present invention, and even the amount of logic gate of the 1-D array architecture in wider-range search is more than that of the present invention. Indeed, it is obvious that the performance of the present invention is superior to other architectures in terms of “normalized processing capability per gate” and “normalized power”.

TABLE 2

| | | | | | Required | Gate | | Gate- | |
|---|---|---|---|---|---|---|---|---|---|
| | | No. | Cycles | Required | Freq. | Count | | Level | |
| Architec | | of | per | Memory | for CIF | @50 | | Power | |
| ture | Description | PE | MV | I/O | 30 fps | MHz | NPCPG | @50 MHz | NP |
| [1] Yang | 1-D semi- | 32 | 8192 | 24 | 97.32 | 28.0K | 0.13 | 26.0 mW | 2.99 |
| | systolic | | | bits | MHz | | | | |
| [2] AB1 | 1-D | 16 | 24064 | 256 | 285.88 | 3.8K | 0.32 | 11.7 mW | 3.95 |
| | systolic | | | bits | MHz | | | | |
| [2] AB2 | 2-D | 256 | 1504 | 128 | 17.87 | 95.1K | 0.20 | 227.8 mW | 4.82 |
| | systolic | | | bits | MHz | | | | |
| [3] | 2-D | 256 | 2209 | 8 | 26.24 | 100.6K | 0.13 | 147.2 mW | 4.57 |
| Hsieh* | systolic | | | bits | MHz | | | | |
| [4] Tree | Tree | 256 | 1024 | 2048 | 12.17 | 56.1K | 0.51 | 179.5 mW | 2.59 |
| | structure | | | bits | MHz | | | | |
| [5] Yeo | 2-D semi- | 1024 | 256 | 24 | 3.04 | 447.4K | 0.26 | 1052.6 mW | 3.79 |
| | systolic | | | bits | MHz | | | | |
| [6] Lai | 1-D semi- | 1024 | 256 | 24 | 3.04 | 387.6K | 0.30 | 845.6 mW | 3.04 |
| | systolic | | | bits | MHz | | | | |
| [7] SA* | 2-D | 256 | 1024 | 16 | 12.17 | 126.5K | 0.23 | 258.0 mW | 3.72 |
| | systolic | | | bits | MHz | | | | |
| [7] SSA* | 2-D semi- | 256 | 1024 | 16 | 12.17 | 106.0K | 0.27 | 280.1 mW | 4.04 |
| | systolic | | | bits | MHz | | | | |
| Ours | Based on | 16 | 1635 | 256 | 19.42 | 17.9K | 1.00 | 43.4 mW | 1.00 |
| | GEA | | | bits | MHz | | | | |

TABLE 3

| | | | | | Required | Gate | | Gate- | |
|---|---|---|---|---|---|---|---|---|---|
| | | No. | Cycles | Required | Freq. | Count | | Level | |
| Architec | | of | per | Memory | for CIF | @50 | | Power | |
| ture | Description | PE | MV | I/O | 30 fps | MHz | NPCPG | @50 MHz | NP |
| [1] Yang | 1-D semi- | 32 | 16384 | 24 | 194.64 | 56.0K | 0.10 | 52.0 mW | 3.78 |
| | systolic | | | bits | MHz | | | | |
| [2] AB1 | 1-D | 16 | 80896 | 256 | 961.04 | 3.8K | 0.30 | 11.7 mW | 4.20 |
| | systolic | | | bits | MHz | | | | |
| [2] AB2 | 2-D | 256 | 5056 | 128 | 60.07 | 95.1K | 0.19 | 227.8 mW | 5.12 |
| | systolic | | | bits | MHz | | | | |
| [3] | 2-D | 256 | 6241 | 8 | 74.14 | 100.6K | 0.15 | 147.2 mW | 4.08 |
| Hsieh* | systolic | | | bits | MHz | | | | |
| [4] Tree | Tree | 256 | 4096 | 2048 | 48.66 | 56.1K | 0.40 | 179.5 mW | 3.27 |
| | structire | | | bits | MHz | | | | |
| [5] Yeo | 2-D semi- | 1024 | 256 | 24 | 3.04 | 1790.0K | 0.20 | 4210.3 mW | 4.79 |
| | systolic | | | bits | MHz | | | | |
| [6] Lai | 1-D semi- | 1024 | 256 | 24 | 3.04 | 1550.4K | 0.23 | 3382.4 mW | 3.84 |
| | systolic | | | bits | MHz | | | | |
| [7] SA* | 2-D | 256 | 4096 | 16 | 48.66 | 126.5K | 0.18 | 258.0 mW | 4.69 |
| | systolic | | | bits | MHz | | | | |
| [7] SSA* | 2-D semi- | 256 | 4096 | 16 | 48.66 | 106.0K | 0.21 | 280.1 mW | 5.90 |
| | systolic | | | bits | MHz | | | | |
| Ours | Based on | 16 | 5187 | 256 | 61.62 | 17.9K | 1.00 | 43.4 mW | 1.00 |
| | GEA | | | bits | MHz | | | | |

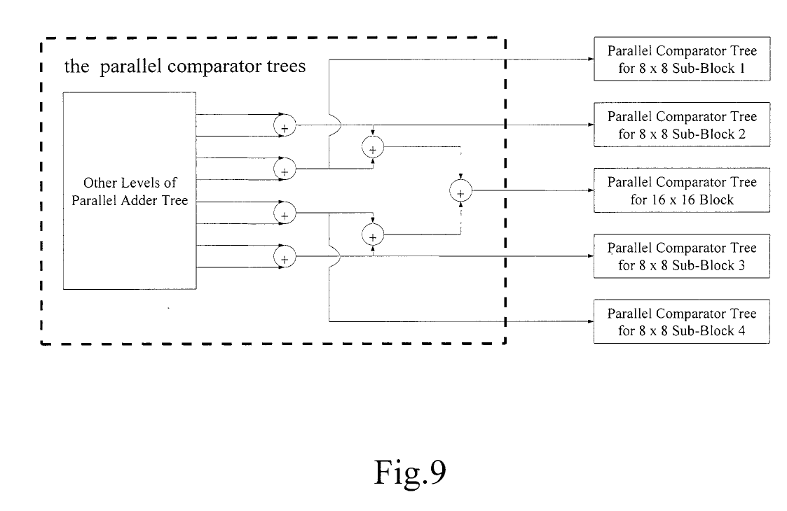

With respect to the video compression standard of the next generation, for example, H.263+, MPEG-4 and so on, other types of motion estimation mode may be provided. The block used in the motion estimation algorithm of the video compression standard of the next generation is not limited to the traditional block size of 16×16, but can produce four motion vectors by four 8×8 sub-blocks within a 16×16 pixel block. If the video compression algorithm can appropriately determine which motion vectors should be used first, the encoding efficiency can be promoted significantly. This motion estimation mode is called “advanced prediction mode”. The hardware architecture according to the present invention can readily support the advanced prediction mode with the addition of four parallel comparator trees, as shown in FIG. 9. If it is inclined to enable the architecture of the present invention to support advanced prediction mode, using Level=4 to design the circuit topology can attain a better encoding efficiency.

Accordingly, the present invention can allow the data flow to be more regular, smoother, and more adapted for hardware implementation, and is capable of removing the drawbacks encountered by the prior (multi-level) successive elimination algorithm. The present invention is also provided with a high reliability, great computation capability, and a minimum reduced power consumption for the logic gates thereof under the condition of the same throughput of motion vector.

Although the present invention has been described and illustrated in detail, it is to be clearly understood that the same is by the way of illustration and example only and is not to be taken by way of limitation, the spirit and scope of the present invention being limited only by the terms of the appended claims.

References:

K. M. Yang, M. T. Sun, and L. Wu, “A family of VLSI designs for the motion compensation block-matching algorithm,” IEEE Trans. on Circuits and Systems, vol. 36, no. 2, pp. 1317-1358, October. 1989.

T. Komarek and P. Pirsch, “Array architectures for block matching algorithms,” IEEE Trans. on Circuits and Systems, vol. 36, no. 2, pp. 1301-1308, October. 1989.

C. H. Hsieh and T. P. Lin, “VLSI architecture for block-matching motion estimation algorithm,” IEEE Trans. on Circuits and Systems for Video Technology, vol. 2, no. 2, pp. 169-175, June. 1992.

Y. S. Jehng, L. G. Chen and T. D. Chiueh, “An efficient and simple VLSI tree architecture for motion estimation algorithms,” IEEE Trans. on Signal Processing, vol. 41, no. 2, pp. 889-900, February. 1993.

H. Yeo and Y. H. Hu, “A novel modular systolic array architecture for full-search block matching motion estimation,” IEEE Trans. on Circuits and Systems for Video Technology, vol. 5, no. 5, pp. 407-416, October. 1995.

Y. K. Lai and L. G. Chen, “A data-interlacing architecture with two-dimensional data-reuse for full-search block-matching algorithm,” IEEE Trans. on Circuits and Systems for Video Technology, vol. 8, no. 2, pp. 124-127, April. 1998.

Y. H. Yeh and C. Y. Lee, “Cost-effective VLSI architectures and buffer size optimization for full-search block matching algorithms,” IEEE Trans. on VLSI Systems, vol. 7, no. 3, pp. 345-358, September. 1999.

What is claimed is:

1. A global elimination algorithm for motion estimation comprising steps of:
representing current blocks within current frame in candidate blocks within reference frame on each search location in terms of coarse patterns;
comparing said coarse patterns in said current block and said candidate blocks;
searching M candidate blocks that hold a coarse pattern similar to said current block, and comparing fine patterns of said M candidate blocks with those of said current blocks; and
selecting the candidate block that holds a minimum of difference of said fine patterns of said M candidate blocks.

2. The global elimination algorithm according to claim 1 wherein said M has a value ranged between 1 and 63.

3. The global elimination algorithm according to claim 1 wherein a motion vector corresponding to a minimum of differences of said fine patterns of said candidate blocks is an estimated motion vector.

4. The global elimination algorithm according to claim 1 wherein said coarse pattern is one of a successive elimination algorithm value and a multi-level successive elimination algorithm value.

5. The global elimination algorithm according to claim 1 wherein said differences of said fine patterns of said candidate blocks is a sum of absolute difference.

6. The global elimination algorithm according to claim 1 wherein said M candidate blocks are located on M search locations having a minimum of fine patterns.

7. A hardware architecture of performing global elimination algorithm for motion estimation, comprising:
a systolic module for computing coarse patterns of each sub-blocks in parallel;
an adder tree for comparing each coarse pattern of current blocks with each coarse pattern of candidate blocks, wherein said adder tree is reusable to comparing each fine pattern of said current blocks with each fine pattern of said candidate blocks;
at least one comparator tree for searching for M candidate blocks that has a coarse pattern similar to said current block;
a control device for controlling operations of said systolic module, said adder tree and said comparator tree; and
at least one memory for storing data of said current block and said candidate blocks.

8. The hardware architecture according to claim 7 wherein said systolic module includes processing unit for computing a coarse pattern within said current block and said candidate block.

9. The hardware architecture according to claim 7 wherein said comparator tree is used to save a similitude of said M candidate blocks and corresponding motion vector thereof in a register, compare said similitude of said M candidate blocks with a similitude of an inputted candidate block, searching for a most dissimilar one to said current block among said M candidate blocks and said inputted candidate block, replacing said inputted candidate block with one that is dissimilar to said current block and is part of candidate blocks in said register, and replacing said inputted candidate block one of those that are dissimilar to said current block and is part of candidate blocks in said register.

10. The hardware architecture according to claim 7 wherein said M has a value ranged between 1 and 63.

11. The hardware architecture according to claim 9 wherein said M has a value ranged between 1 and 63.

12. The hardware architecture according to claim 7 further comprising four additional adder trees coupled to said adder tree, wherein said hardware architecture is enabled to support advance prediction mode by slightly modifying a configuration of said control unit.

13. The hardware architecture according to claim 7 wherein said coarse pattern is one of a successive elimination algorithm value and a multi-level successive elimination algorithm value.

14. The hardware architecture according to claim 7 wherein said differences of said fine patterns of said candidate blocks is a sum of absolute difference.

15. The hardware architecture according to claim 7 wherein said M candidate blocks are located on M search locations having a minimum of fine patterns.
